(19) United States
(12) Patent Application Publication
(10) Pub. No.: US 2006/0028077 A1
(43) Pub. Date: Feb. 9, 2006

(54) Flat vibration brushless motor

(76) Inventors: Tadao Yamaguchi, Isesaki-shi (JP); Takeshi Osaki, Isesaki-shi (JP); Kentaro Fujii, Isesaki-shi (JP); Naohisa Koyanagi, Isesaki-shi (JP)

Correspondence Address: JORDAN AND HAMBURG LLP, 122 EAST 42ND STREET, SUITE 4000, NEW YORK, NY, 10168, US

(21) Appl. No.: 11/197,629

(22) Filed: Aug. 3, 2005

(30) Foreign Application Priority Data
Aug. 4, 2004 (JP) 2004-227499
Sep. 9, 2004 (JP) 2004-262364
Sep. 21, 2004 (JP) 2004-272899
Dec. 17, 2004 (JP) 2004-365770
Mar. 4, 2005 (JP) 2005-060470
Mar. 31, 2005 (JP) 2005-100983

(51) Int. Cl. H02K 7/06

(52) U.S. Cl. 310/81

(57) ABSTRACT

An eccentric rotor rotatably accommodated via a shaft in a housing at least one part of which is made nonmagnetic or weakly magnetic comprises a rotor case, an axial air-gap magnet held in the rotor case, a nonmagnetic eccentric weight fixed on the rotor case outward of the magnet, and a bearing support disposed on the rotor case inward of the magnet, and a stator disposed on a portion of the housing and driving the eccentric rotor across an axial gap comprises a shaft support portion provided in the center, a bracket having a detent torque generation part formed of a magnetic body disposed on a periphery of the shaft support portion, at least two air-core armature coils wired in a single-phase and provided in a stator base attached to the bracket, a drive circuit member disposed so as not to overlap with the air-core armature coils and supplying electric to the air-core armature coils, and a feed terminal to be connected to the drive circuit member.

### TECHNICAL FIELD

The present invention relates to a flat brushless vibration motor suitable for silent alarm means; more specifically, it relates to a flat vibration motor used as a single unit or incorporated in a magnetic sound transducer (commonly known as a micro speaker) or the like tand configured as a central magnetic pole.

### BACKGROUND ART

Conventionally, as a flat brushless vibration motor comprising an eccentric rotor, a fixed yoke type used as an axial air-gap slotless type is known. See Japanese Utility Model Registration 2549357.

Also, there is a magnetic sound transducer such that a pair of plate-shaped elastic bodies are supported by a frame body so as to oppose each other, a magnetic field generator comprising a yoke and magnet is attached to one plate-shaped elastic body, a ring-shaped moving voice coil is attached to the other plate-shaped elastic body, the coil is disposed within the magnetic field of the magnetic field generator, and currents with different frequencies are applied in a switchable manner. See Laid-Open Japanese Patent Application H 10-117472.

Also, there is a device wherein, as a vibration source, a cylindrical vibration motor in which an eccentric weight is disposed on an output shaft to obtain centrifugal vibrations is disposed in a lateral direction. See Laid-Open Japanese Patent Application 2001-103589.

However, with such constitutions, a magnetic sound transducer cannot be miniaturized.

To address this issue, there is a magnetic sound transducer having a cored type, that is, a radial air-gap type motor, incorporated therein. See Laid-Open Japanese Patent Application 2003-125474.

However, with such a constitution, because it is a cored type and a spindle is attached to an output shaft, it cannot achieve a low profile, and because it uses a brush commutator and a high-speed motor, it is not sufficiently durable for speaker life.

Such a magnetic sound transducer is affected more by the life of motor as silent alarm means, than by speaker life; therefore, there is demand for a motor with longer life and reduction in overall profile. In order to meet such market demands, a thin brushless motor is desirable.

However, such a thin brushless motor entails troublesome issues when integrated into a magnetic sound transducer. Specifically, in order to increase sound pressure, a magnet with a strong unipolar magnetic field such as a neodymium magnet is used as a speaker excitation magnet; however, this greatly influences the rotor magnet in the motor. Therefore, when such a magnet is used with a single Hall sensor for reasons of disposition capacity, a detent generation member is adversely impacted, and there are start-up related problems.

Also, if the motor size is required to be thin, at 3 mm or less, then an axial air-gap slotless type must be used, and metal members such as rotor, housing, and the like must also be thin, and the gap also needs to be small.

Therefore, even with a general brushless vibration motor not incorporated in a magnetic sound transducer, the rotor magnet used therein needs to be much stronger due to miniaturization. However, for purposes of miniaturization, the rotor yoke size also needs to be reduced. As a result, magnetic field leakage easily occurs, and with a fixed yoke slotless type motor, in the space between the magnetic portions of housing constituted by case and bracket, there is main magnetic field absorption loss as well as absorption loss due to the magnetic field leakage.

### SUMMARY OF THE INVENTION

It is an object of the present invention to prevent problems in motor rotation characteristics even when there is magnetic field leakage, thereby enabling use of the motor as a magnetic pole piece receiving an outside magnetic field.

Means for Solving the Problems:

To solve such problems, a flat brushless vibration motor, as described in claim 1, can be achieved by a device comprising:
a housing at least one part of which is made nonmagnetic or weakly magnetic;
an eccentric rotor rotatably accommodated in the housing via a shaft;
the eccentric rotor comprising a rotor case, an axial air-gap magnet held in this rotor case, a nonmagnetic eccentric weight fixed in the rotor case outward of this magnet, and a shaft bearing portion disposed on the rotor case inward of the magnet; and
a stator disposed on a portion of the housing and driving the eccentric rotor across an axial gap.

The stator comprises a shaft support portion provided in the center, a bracket having detent torque generation parts made of a magnetic body and disposed on the periphery of the shaft support portion, a stator base attached to the bracket, at least two air-core armature coils wired in a single-phase and provided on this stator base, a drive circuit member disposed so as not to overlap with the air-core armature coils and supplying electric to the air-core armature coils, and a feed terminal connected to the drive circuit member.

Specifically, a preferred housing is constituted so as to extend radially outward at the bottom as a flange for attachment.

More specific means for solving the problems, can be achieved by a constitution wherein to avoid influence from magnetic field leakage of the axial air-gap magnet on the housing, the housing is formed of a nonmagnetic or weakly magnetic body, excluding at least the detent torque generation parts.

Further, a case constituting the housing can be achieved by a constitution wherein the case has a magnetic body on the lateral periphery, and a part of a ceiling portion is formed of a nonmagnetic or weakly magnetic body and combined with the magnetic body on the lateral periphery.

Further, another means for solving the problems, can be achieved by a constitution wherein the eccentric rotor comprises magnetic balance means comprising a magnetic body having an outer diameter concentric to the rotation center and outward of the axial air-gap magnet.

In a preferred configuration, magnetic balance means, is a brim portion extending along the entire periphery of the rotor case in the radial direction, on a portion of which an arc-shaped nonmagnetic eccentric weight is disposed by combining recesses and protrusions.

In order to avoid influence from magnetic field leakage of the axial air-gap magnet on the housing, a constitution may be employed wherein the case ceiling portion is slightly larger than the outer diameter of the axial air-gap magnet and swells upward in the axial direction.

To make use of the swelled portion, a constitution is preferred wherein an eccentric rotor auxiliary plate is accommodated, so that the eccentric weight is held down by a portion of the outer periphery thereof, and a bearing is held down by a portion of the inner periphery thereof.

Another specific means for solving the problems, can be achieved by a constitution wherein the housing comprises a case that is at least partially nonmagnetic and a yoke bracket assembled at the opening of the case that is at least partially magnetic, and comprising: a shaft support portion disposed on the center of the yoke bracket, at least two detent torque generation parts disposed radially outward of the shaft support portion, at least two single-phase wiring type air-core armature coils that are fixed to the stator base when the number of magnetic pole pieces of a rotor magnet to be assembled is (2n) (n being an integer 2 or larger), a drive circuit member disposed on the stator base so as not to overlap with the air-core armature coils when seen from the plan view, and a feed terminal part for input in the drive circuit member radially provided integral with the stator base, wherein the detent torque generation parts protrude in the axial direction integrally with the yoke bracket so that they are positioned at least within the air-core armature coils at least 12° from the center of the coils and so that they are accommodated within the thickness of the air-core armature coils.

Specifically, in a preferred configuration, the detent torque generation parts disposed on the bracket, are magnetically separated from the magnetic body on the lateral periphery of the housing.

More specifically, a plurality of detent torque generation parts are radially provided from the center at a magnetism opening angle roughly the same as, or an integral multiple of, that of the magnetic pole pieces of an axial air-gap magnet to be assembled, the tips thereof, as means for magnetic separation, are cut off from the magnetic member constituting the housing, and the detent torque generation parts are disposed on a nonmagnetic end bracket constituting a bracket which is a part of the housing.

Also, the nonmagnetic end bracket is made of a metal body, is thicker than a detent torque generation part, and has formed at the center thereof a shaft support portion, the center of the detent torque generation part is press fitted on the shaft support portion, and the cut-off tip is embedded in the nonmagnetic end bracket.

Also, another means for solving the problems can be achieved by a device comprising a shaft disposed on a shaft support portion in the center of one of the above brackets; at least two detent torque generation parts disposed radially outward thereof; at least two single-phase wiring type air-core armature coils fixed on a stator base when a stator base comprising a print wiring board is attached to the bracket and the number of magnetic pole pieces for the magnet of the rotor is (2n) (n being an integer 2 or larger); a drive circuit member disposed on the stator base so as not to overlap with the air-core armature coils when seen from the plan view; a feed terminal part for input in the drive circuit member and provided integral with the stator base; wherein the rotor comprises an axial air-gap magnet having a plurality of magnetic pole pieces and a rotor yoke holding the magnet, is rotatably fitted on the stator via the shaft, and is accommodated in a housing comprising a case in which a magnetic body is provided on the lateral periphery and the bracket, and the detent torque generation parts axially protrude integrally from the yoke bracket so as to be positioned on an inner diameter portion of the air-core armature coils, at least 12° from the center of the coils.

With the invention a flat brushless vibration motor is configured so that because members do not overlap one another, it can be made thin, and because the housing is nonmagnetic or weakly magnetic, it is not influenced by the axial air-gap magnet.

With the invention, attachment of a motor is facilitated.

With the inventions, a magnetic pole for receiving an outside magnetic field is constituted by a magnetic body on the lateral periphery, and even if there is magnetic flux leakage from an axial air-gap magnet, absorption of such magnetic flux leakage by the motor housing is inhibited by the nonmagnetic housing, preventing loss at time of rotation. With the inventions, magnetic balance means causes magnetic field leakage from an axial magnet to be even, so that there is no danger of an unbalanced magnetic field being applied on the housing, and even if there are emissions from an outside magnetic field these are evenly received, so that there is no danger of the magnetic field of the axial magnet being affected.

With the invention, influence from magnetic field leakage of an axial magnet on a case serving as a housing decreases, and the case itself may be formed of a magnetic body as well.

With the invention, strength of the eccentric weight on the outer periphery and the inward bearing is secured.

With the invention, because the thickness of the detent torque generation member disposed on an inner diameter of a coil can be substantially ignored and the case ceiling portion is nonmagnetic, even if there is magnetic field leakage from an axial air-gap magnet, effects such as absorption loss are prevented.

With the inventions, even if an outside magnetic field is emitted on the case lateral periphery, there is no effect on the detent torque generation parts, and strength can be maintained even if the detent torque generation parts are thin.

With the invention, the thickness of a detent torque generation member disposed on an inner diameter of a coil can be substantially ignored, and because of the separation of at least 12° from the coil center, start is easy, whether a magnetic pole piece peak or a neutral portion has stopped at a detent torque generation part position.

To prevent magnetic field leakage from affecting the motor even as an outside magnetic field is being received, the case comprising the motor housing has a magnetic body on a lateral periphery thereof, a ceiling portion is formed of a nonmagnetic body and a detent torque generation part disposed on the bracket and receiving the magnetic field of the rotor magnet is cut off from the magnetic portion.

### BRIEF DESCRIPTION OF THE DRAWINGS

FIG. 1 illustrates a cross-sectional view of an embodiment of a flat brushless vibration motor of the present invention incorporated in a magnetic sound transducer (embodiment 1); FIG. 2 illustrates a cross-sectional view of a second embodiment of the same (embodiment 2); FIG. 3 illustrates a cross-sectional view of a third embodiment of the same (embodiment 3); FIG. 4 illustrates a plan view of the eccentric rotor of FIG. 3; FIG. 5 illustrates a cross-sectional view of a modification of the embodiment of FIG. 3 (embodiment 4); FIG. 6 illustrates a cross-sectional view of another embodiment of the present invention (embodiment 5); FIG. 7 illustrates a plan view of an essential portion on the bracket side of FIG. 6; FIG. 8 illustrates a cross-sectional view of an essential portion of a modification of FIG. 6 (embodiment 6); FIG. 9 illustrates a cross-section of another embodiment of the present invention (embodiment 7); and

FIG. 10 illustrates a plan view of the stator of FIG. 9.

### DESCRIPTION OF THE PREFERRED EMBODIMENTS

### Embodiment 1

A magnetic sound transducer S containing a flat brushless vibration motor constituting the present invention comprises a speaker housing 1 in the form of a shallow cylinder made of resin, a flat vibration motor M disposed in the center thereof and having an eccentric rotor incorporated therein, a ring-shaped moving voice coil 2 caused to face a radial outer periphery of the motor across a gap and formed as a multilayer solenoid type, a film-like diaphragm 3 made of a synthetic resin to which one end of the coil is attached and the outer periphery of which is attached to the housing, and a ring-shaped excitation magnet 4 disposed in the housing across a gap with respect to the outer periphery of the moving voice coil 2. A terminal 2a of the moving voice coil 2 is made to conform to the diaphragm 3 by adhesion or the like, and is led to a feed terminal part B across a partial space 1a in the speaker housing 1 lateral surface.

These members are respectively covered with a cap 5 in the shape of an upside down dish attached to the speaker housing 1 made of a resin on the outer periphery portion so as to hold down the outer periphery of the diaphragm 3. Here, the cap is formed of nonmagnetic stainless steel, and a number of sound output holes 5a are provided in order to lead audio generated from the diaphragm to the outside. As the diaphragm 3 is extremely thin, it is indicated in the figures with a simple solid line.

Here, the flat vibration motor M is constituted by a single-phase Hall sensor to be described later, wherein as means for avoiding influence from a magnetic field of an excitation magnet, a motor housing comprising a case and bracket is made nonmagnetic or weakly magnetic, and between the motor and moving excitation coil, there is provided a cylindrically formed magnetic body J with thickness of about that of the motor and having a notch to partially lead a feed terminal.

This magnetic body J is configured so that a bottom portion is fixed on a bracket 6 constituting a housing H of the motor M uniformly or at a plurality of locations by laser welding indicated by Y; further, a flange Ja extends in a radial direction, the base of the magnet 4 is attached thereto and the flange Ja is attached to the base end of the speaker housing 1 by an adhesive or the like so as to include a lead hole for the feed terminal part B, thus supporting the motor.

By this magnetic body J, a magnetic field of an excitation magnet can be received, preventing entrance thereof into the motor.

Because the flange Ja serves as a return pass plate for the excitation magnet, the flange J constitutes a closed magnetic path, reducing magnetic field leakage and preventing entrance thereof into the motor.

On an upper portion of the excitation magnet 4, a yoke plate 4a covering the entire periphery of the magnet is disposed, and a magnetic field directed at the moving coil is constituted. In other words, the magnetic body J functions to improve the effective magnetic flux density relating to the moving voice coil 2.

Here, if a flat brushless vibration motor M is not mounted in a magnetic sound transducer, the magnetic body J is not required.

The motor M constituting the present invention, as illustrated in FIG. 2, comprises a Hall sensor type single-phase brushless motor. As is well-known, for purposes of automatic start, a single-phase brushless motor needs to have a rotor stop at a prescribed position. However, when a magnetic body is used for the bracket 6 and case 7, the magnetic force of the large magnet renders start difficult; therefore, normally, these need to be nonmagnetic except for a detent torque generation part 8. When a motor with thickness of about 2 mm is used, the rotor case holding a magnet also must be thin, meaning that above, on the side opposite the gap, flux leakage increases, and the case 7 covering such a rotor needs to be nonmagnetic.

An eccentric rotor R is constituted such that an axial air-gap magnet 9 is adhered to a thin rotor yoke 10. This thin rotor yoke 10, which comprises a flat portion 10h receiving a magnetic field of the axial air-gap magnet 9, an outer diameter side hanging portion 10a and an inner diameter side hanging portion 10b integral with the flat portion 10h, is configured so as to enclose the axial air-gap magnet 9, thus achieving strong adhesion.

This thin rotor yoke 10 is constituted such that two tongues 10c protrude horizontally in the normal line direction from the outer diameter side hanging portion 10a and integrally therewith at a prescribed angle.

The arc-shaped eccentric weight W is constituted such that on one surface thereof recesses Wa for receiving the tongues 10c with thickness roughly equal to that of the tongues 10c are formed at positions corresponding to the tongues 10c. While the recesses Wa are respectively fitted with the tongues 10c on the outer diameter side hanging portion 10a of the rotor yoke 10, the eccentric weight W is fixed to the outer diameter side hanging portion 10a by adhesion or the like. The tongues 10c (not shown in drawings) are formed in normal line directions at two places, thus restricting radial movement of the eccentric weight W. The outer periphery of the axial air-gap magnet 9 is covered with a hanging portion on a lateral periphery of the rotor yoke 10, reducing magnetic flux leakage into the case 7. Further, because of the space for disposing the eccentric weight W, leakage flux of the axial air-gap magnet radially outward does not reach outside of the case 7 even when the case is nonmagnetic, thus constituting means for avoiding influence from a magnetic field of the excitation magnet 4.

Therefore, even though the magnetic body J is disposed on the outer periphery of the case 7, there is no influence on the rotation of the eccentric rotor R. The eccentric rotor R thus configured is rotatably fitted via a bearing 13 on a shaft 12 the end of which is fixed to the bracket in advance by laser welding indicated by L (here, in the center of the detent torque generation member 8). The shaft tip is also laser welded after the eccentric rotor is fitted thereto. On the opening of the case 7 as well, the bracket side is also laser welded. Therefore, the motor has a monocoque construction, ensuring strength even with thin members.

A stator ST driving the eccentric rotor R comprises the detent torque generation member 8 attached to the nonmagnetic bracket 6 by adhesion, spot welding or the like, two single-phase air-core armature coils 14 (only one is shown in the drawings) thereabove, wired in series to each other and disposed on the stator base 11 comprising a flexible substrate, and a drive circuit member D disposed so as not to overlap with the coils 14. Because the drive circuit member D has a certain thickness, it is positioned at a location other than where the detent torque generation member 8 is located.

Therefore, because the drive circuit member D is incorporated in the brushless motor M, the feed terminal part B needs only two terminals, one positive and one negative, meaning that together with the two conductive terminals of the moving voice coil 2, only four feed terminals are needed, thus making for an extremely simple constitution.

### Embodiment 2

In the second embodiment illustrated in FIG. 2, a constitution of a magnetic sound transducer S is identical to that of the above described embodiment 1, which identical members, including a brushless vibration motor M, are given the same reference symbols and explanation thereof is omitted.

This flat brushless motor M is characterized in that a case 77 is different from that of the above embodiment. This case 77 comprises a tube 7b formed of a magnetic material in a cylindrical shape and a flange 7d formed continuously from the bottom of the tube 7b, and an outer periphery section of the flange 7d is fixed on the bottom end of the speaker housing 1. The excitation magnet 4 is attached to the speaker housing 1 and flange 7d.

The case 77 is constituted such that a lateral periphery portion thereof, together with the excitation magnet 4 and yoke plate 4a, forms a magnetic path for speaker that acts on the voice coil 2; it also serves as housing for the brushless motor M. The flange 7d may be assembled as a separate body provided it is magnetically continuous with the tube 7b.

The upper end portions of the case 77 extend slightly toward the center, and a brim 7c is formed thereon. The brim 7c extends from the upper end of the tube 7b in an annular shape. As this brim 7c operates to pull a magnetic flux from above generated from the magnet 4, the section serving as a yoke of the magnet 4 is expanded. Therefore, when using, for example, a thin motor M and the height of the cylindrical body 7b is not sufficient, the volume of a magnetic flux applied to the voice coil 2 can be increased.

On the brim 7c, a disk-like lid 7a is attached so as to cover the eccentric rotor R. This brim 7c and lid 7a form a ceiling portion of the case 77. The brim 7c and lid 7a are fixed by welding, crimping or the like, with the outer periphery of the lid 7a positioned by means of a step, for example, provided on the brim 7c. As means for avoiding influence from a magnetic field of an excitation magnet, the lid 7a is formed of nonmagnetic metal, resin material, or a stainless steel plate that is less magnetic than the tube 7b.

In the center of this lid 7a, a recess 7e for fixing one end of the shaft 12 is provided, and the shaft 12 is fixed therein by welding, press fitting or the like. Because the lid 7a is provided, the motor M is sealed, preventing infiltration of dust. Also, if the shaft 12 is fixed as in this embodiment, a fixed shaft type motor can be configured. The other end of the shaft 12 is attached to and fixed in a recess 6e of the bracket 6, and laser welded from the outside as necessary.

In this embodiment, the inner periphery edge 7cc of the brim 7c is positioned in the radial direction within the sphere of rotating of the weight W, and the radial direction position of the inner periphery edge 7cc is further to the outer periphery than the outer diameter side hanging portion 10a. With such a constitution, leakage flux from the rotor R is extremely low, so that the magnetic field does not affect the case 77 and rotation of the rotor is not impeded.

Also, because of this brim 7c, a magnetic field efficiently acts upon the moving voice coil 2. Alternatively, when the tube 7b is sufficient as a yoke, the lid 7a may be attached on the upper end of the tube 7b without needing to provide the brim 7c. In such a case, steps for forming a brim and the like are omitted.

Also, the tube 7b is positioned so as to be separated from the outer diameter side hanging portion 10a by the length of the weight W. By using the weight W to separate the outer periphery side of the rotor R from the tube 7b, which is a magnetic body, influence on the rotor by the tube 7b can be eliminated.

### Embodiment 3

FIG. 3 illustrates a third embodiment, in which magnetic balance is attained on the eccentric rotor. Here too, members identical to those of the above described embodiments are given the same reference symbols and explanation thereof is omitted.

The flat brushless vibration motor M constituting the present invention comprises a Hall sensor type single-phase brushless motor. As is well-known, for purposes of automatic start, a single-phase brushless motor needs to have a rotor stop at a prescribed position. However, when a magnetic body is used for the bracket 6 and case 7, the magnetic force of the large magnet renders start difficult, and for this reason a large gap is required. Normally, however, to reduce the motor size, the bracket 6 needs to be a nonmagnetic body except for the detent torque generation part 8. When a motor with thickness of about 2 mm is used, the rotor yoke 10 holding a magnet also must be thin, meaning that above, on the side opposite the gap, flux leakage increases, and the case 7 covering such a rotor needs to be nonmagnetic.

Generally, such a nonmagnetic housing may also be used. However, to be incorporated in a magnetic sound transducer, when the case 7 is nonmagnetic, a magnetic path for the speaker excitation magnetic 4 is not constituted; therefore, at least a lateral periphery section 7a needs to be a magnetic body. Thus, in this embodiment, as means for avoiding influence from a magnetic field of an excitation magnet, only a ceiling portion facing a rotor magnet has a nonmagnetic stainless steel plate 7b set therein.

The eccentric rotor R is constituted such that a ring-shaped air-gap magnet 9 with a rectangular cross-section is adhesively bonded to the thin rotor yoke 10. This thin rotor yoke 10 is formed of a thin magnetic plate material, comprises the flat portion 10h receiving a magnetic field of the axial air-gap magnet 9, the outer diameter side hanging portion 10a formed integral with the flat portion 10h and in a cylindrical shape, and the cylindrical inner diameter side hanging portion 10b, also integral with the flat portion 10h, for receiving the bearing 13, and is configured so that the flat portion 10h and the outer diameter side hanging portion 10a enclose the axial air-gap magnet 9, ensuring that the magnet 9 is strongly adhered. The outer diameter side hanging portion 10a [10b in Japanese] is formed in a cylindrical shape with a closed periphery and is concentric with the shaft 12, and is magnetically balanced. Therefore, the eccentric rotor thus configured can receive a magnetic field from outside evenly and magnetic field leakage from the motor magnet is also even.

This thin rotor yoke 10 is constituted such that, as shown in FIG. 4, a brim portion 10c is formed in the radial direction along the entire periphery of the outer diameter side hanging portion 10a. This brim portion 10c is configured so that its outer diameter is concentric to the rotation center, and as shown in FIG. 4, holes b into which projections a of the weight W are to be inserted are equidistantly provided along the same circumference. The holes are provided as dummies at locations other than those to which the eccentric weight is to be attached in order to constitute magnetic balance means with respect to outside magnetic fields, and here six are equidistantly provided to correspond to the neutral sections of the axial air-gap magnet 9 magnetized into six magnetic pole pieces.

The arc-shaped eccentric weight W is placed on the brim portion so that, as described above, by combining recesses and protrusions, radial movement is restricted, and is fixed thereto by an adhesive agent or welding. The adhesive agent ensures the rotor yoke is securely fixed to the lower surface and inner diameter surface of the arc-shaped weight, and by combining recesses and protrusions, radial movement of the weight W is restricted.

If the eccentric weight W and rotor yoke 10 are attached with sufficient strength, it is not necessary to form the holes b. Alternatively, if there are holes b, the weight W can be attached with greater strength, and because the outer periphery of the brim portion 10c is in a closed state and is formed in a circular shape concentric to the rotation shaft, magnetic balance of the rotor R is maintained despite the holes b.

The combining of recesses and protrusions may be reversed so that holes are provided on the weight W, and projections are provided on the brim portion 10c. With this configuration, the weight W can be fixed more securely without having to provide holes in the brim portion 10c, improving magnetic balance of the rotor and attaching strength of the weight.

The outer periphery of the axial air-gap magnet 9 is covered by the lateral periphery hanging portion of the rotor yoke 10, reducing magnetic flux leakage in the case 7. Further, as there is a space for disposing the eccentric weight W, radially outward leakage flux of the axial air-gap magnet 9 is prevented from leaking outwardly by the brim portion serving as magnetic balance member, so there is no influence on the rotational action of the eccentric rotor R. The rotor yoke 10 is configured so that a part of the inner diameter side hanging portion 10b is held at the bearing 13 by means such as crimping.

The eccentric rotor R thus configured is rotatably fitted, via the bearing 13, on the shaft 12, the base end of which having been fixed by laser welding at point L1 on the bracket (here, in the center of the detent torque generation member 8) in advance and from the outside. The shaft tip is also laser welded at point L2 after the eccentric rotor is fitted thereto. The bracket can also be laser welded at point L3 to the opening of the case 7 as well. Therefore, the motor employs a monocoque construction, so that strength can be secured even when thin members are used. The case and bracket may be assembled by publicly known means for crimping recesses and protrusions. In the drawings, 10d are holes into which crimp teeth are to be inserted for fitting the bearing 13 onto the rotor case 10 and crimping the edge of the bearing 13; so that there is no magnetic influence from an outside magnetic field, four such holes are provided equidistantly along the same circumference.

A stator driving the eccentric rotor R comprises the detent torque generation member 8 attached to the nonmagnetic bracket 6 by spot welding or the like, thereabove, two single-phase air-core armature coils 14 (only one is shown in the drawings) wired in series to each other and attached to the stator base 11 comprising a flexible substrate, and the drive circuit member D attached so as not to overlap with the coils 14.

Therefore, because the drive circuit member D is incorporated, the feed terminal part B needs only two terminals, one positive and one negative, and including the two conductive terminals of the moving voice coil 2, only four feed terminals are needed; therefore, the flat brushless motor M thus configured can have an extremely simple constitution.

In the motor M thus configured, the lower portion of the case constituting a part of a housing extends radially outward, serving as the flange 7c, this flange portion is joined by welding or the like with the bracket constituting the other portions of the housing, a base portion 4a of the excitation magnet 4 is placed on the flange portion, and this flange 7c is used for attachment to the speaker housing 1. In the drawings, 4b is a magnetic plate for causing the magnetic field of the excitation magnet 4, which is magnetized in the axial direction, to be directed in the radial direction toward the moving voice coil 2.

### Embodiment 4

The embodiment of FIG. 5 is a variation of the embodiments of FIGS. 3 and 4, and elements identical to those in FIGS. 3 and 4 are given the same reference symbols and explanation thereof is omitted.

In view of a constitution of a speaker S in which a cross-section of a diaphragm is hill-shaped, a case 771 constituting a motor housing comprises a swelling up portion 77e formed as one means for avoiding influence from a magnetic field of an excitation magnet. With such a constitution, the side opposite the gap widens, and there is no influence from leakage flux on the case top. Here, the swelling up portion 77e is used and an auxiliary yoke plate 15 is attached to the flat portion 10h of the rotor yoke 10 with an adhesive or by spot welding; this auxiliary yoke plate 15 is designed so that in addition to constituting a magnetic path, its outer diameter is concentric to the rotation center, and this outer diameter partly holds down the eccentric weight W, while the inner diameter side holds down the top of the bearing 13, thereby helping to ensure the strength of these members. Thus, this constitution can withstand problems when, for example, the device is inadvertently dropped. As the auxiliary yoke plate 15 has an outer diameter concentric to the rotation center, magnetic balance with respect to an outside magnetic field is attained. In other words, the outside magnetic field, in this case, a magnetic flux of the speaker excitation magnet 4, is evenly received by the auxiliary yoke plate 15, even when leakage flux has passed through the motor housing, so that there is no influence on the rotor rotation.

### Embodiment 5

FIG. 6 illustrates bracket-side means for avoiding influence from a magnetic field of an excitation magnet.

Specifically, as shown in FIGS. 6 and 7, the flat brushless vibration motor M constituting the present invention has a constitution as shown in FIG. 3, comprising a Hall sensor single-phase brushless motor. As is well-known, for purposes of automatic start, a single-phase brushless motor needs to have a rotor stop at a prescribed position. However, when a magnetic body is used for the case and bracket constituting a housing, the magnetism of the large magnet renders start difficult, and it is therefore necessary to have a large gap. Usually, however, to reduce motor size, for a bracket comprising part of a housing, the housing portion, other than the detent torque generation part 8, needs to be nonmagnetic. For a motor with thickness of about 2 mm, the rotor case holding the magnet must be thin, leakage flux above, from the side opposite the gap, increases, and the case 777 covering such a rotor needs to be nonmagnetic. However, when the case 777 is made nonmagnetic, a magnetic path of the speaker excitation magnet 4 is not formed; therefore, at least on a lateral periphery section, a magnetic body 7a must be provided. Thus, in this embodiment, only a ceiling portion facing the rotor magnet has a nonmagnetic plate 7b set therein.

The motor M is constituted such that the case 777 constituting the housing H is made of magnetic material from the lateral periphery to the bottom portion, and in the radial direction a flange 7a is formed so that it overlaps and is integral with a flange that extends from the bracket 6 in the radial direction. The bracket 6 comprises a part of the detent torque generation member 8 and end bracket 88 formed of nonmagnetic metal integrated therewith.

As shown in FIG. 7, the detent torque generation member 8 comprises thin detent torque generation parts 8b for properly receiving the magnetism from the axial air-gap magnet 9 (described below), a flange 8a to be integrated with a flange 88a of a nonmagnetic end bracket 88, and a shaft fixed portion 8c in the center. The four detent torque generation parts 8b, which are radially formed at opening angles roughly the same as, or an integral multiple of, that of the magnetic pole pieces (here, there are six magnetic pole pieces of the axial air-gap magnet, thus at 60° and 120°), are attached to the nonmagnetic end bracket 88 through a guide 8d by spot welding, adhesively bonding or the like so as to be located at prescribed positions. The speaker excitation magnet 4 is placed on integrated flange 7a, 88a, and these flanges are used to attach the motor M to the speaker housing 1. In other words, this motor is disposed in the speaker center, and serves as a magnetic pole receiving a unipolar magnetic field of the excitation magnet 4.

The invention is characterized by a constitution such that a notch 8e is provided in the detent torque generation part 8 as means for avoiding influence from magnetic flux of the excitation magnet 4, so that a magnetic field of the speaker excitation magnet 4 does not influence the detent torque generation part 8. The notch 8e may be simply cut out using a Thomson die cutter after integration with the nonmagnetic end bracket 88. Alternatively, it may be cut out together with the nonmagnetic end bracket 88.

With such a constitution, the detent function ensures that the stop action is stable as it depends only on the axial air-gap magnet on the motor side.

### Embodiment 6

FIG. 8 is a variation of FIG. 6, having improved integration of a nonmagnetic end bracket and detent torque generation member. More specifically, the nonmagnetic end bracket 888 is at least twice as thick as the detent torque generation member 8 and has formed in the center thereof a shaft support portion 88a, the detent torque generation part 8 is press fitted onto the shaft support portion 88a at the center, and the cut-off tip 8d is embedded in the nonmagnetic end bracket 888. The shaft 12 is fixed on the shaft support portion 88a by laser welding from the outside. Here, a housing comprising the case 777 and nonmagnetic end bracket 888 is assembled by attaching the flanges 7a and 88b to each other by crimping together recesses and protrusions.

With such a constitution, sufficient shaft fixing strength can be maintained, and the detent torque generation member can be easily and securely disposed.

### Embodiment 7

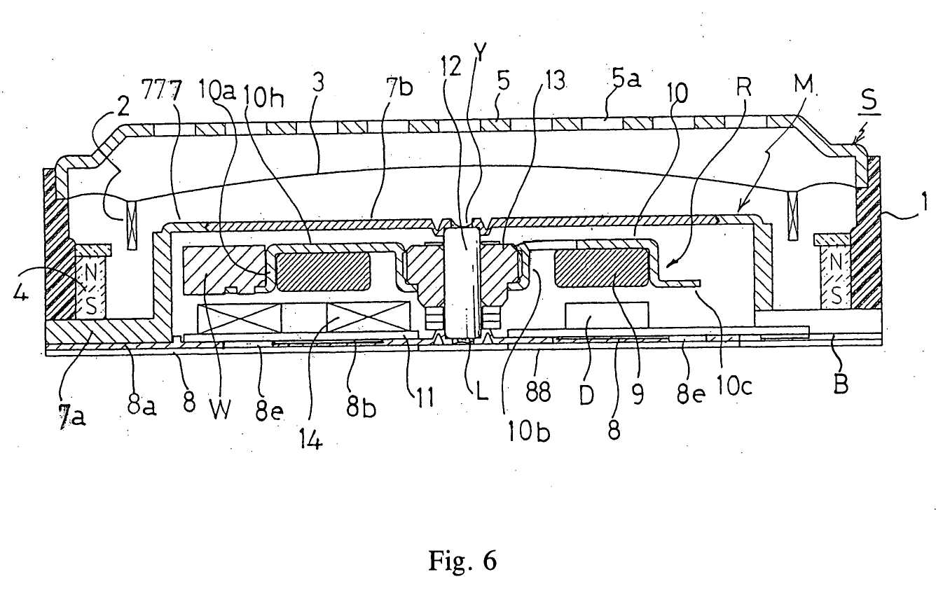

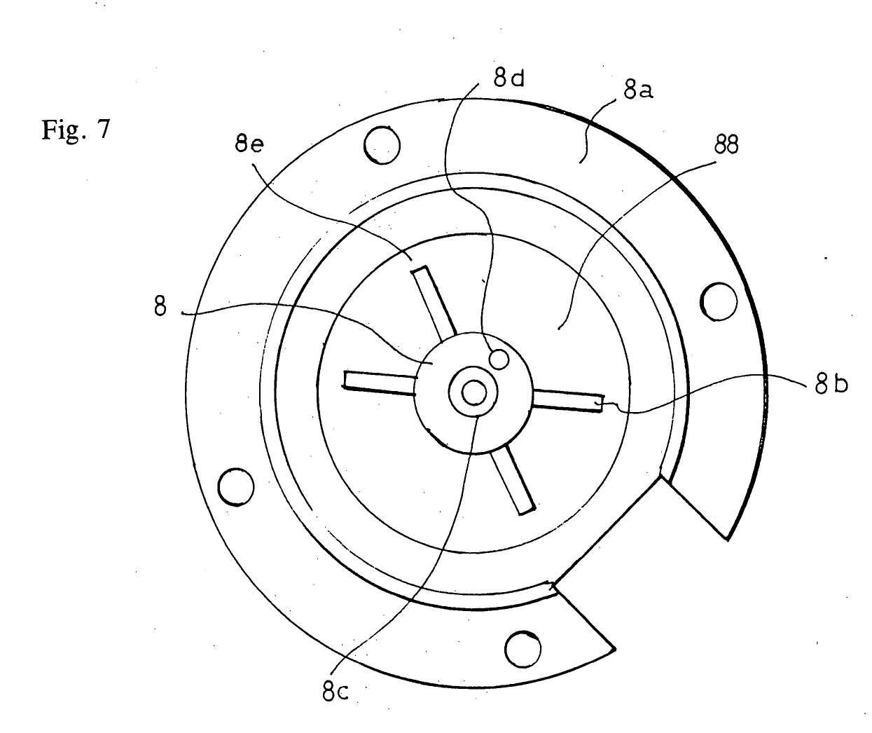

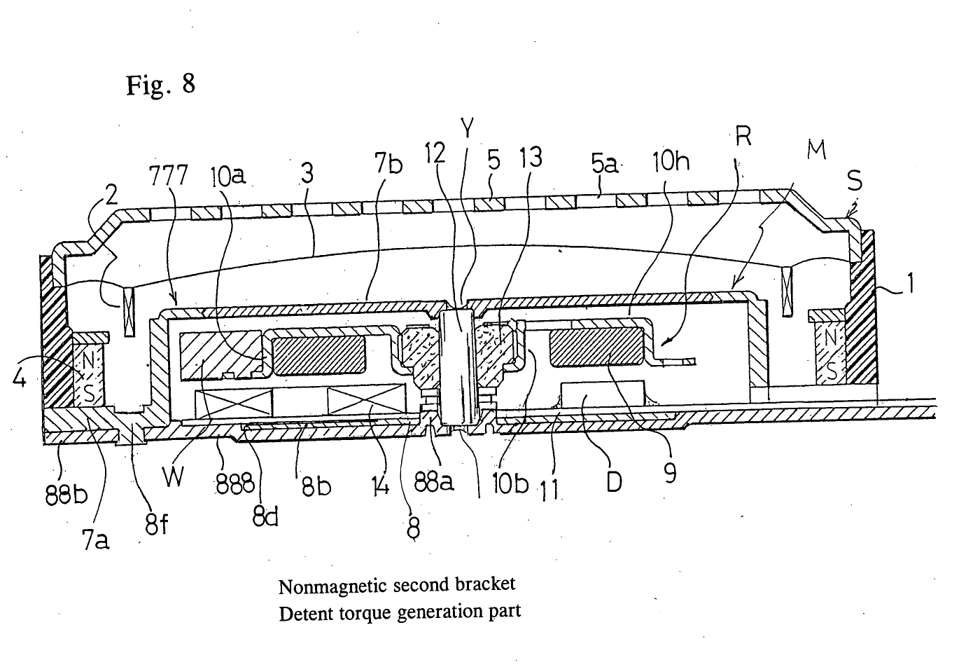

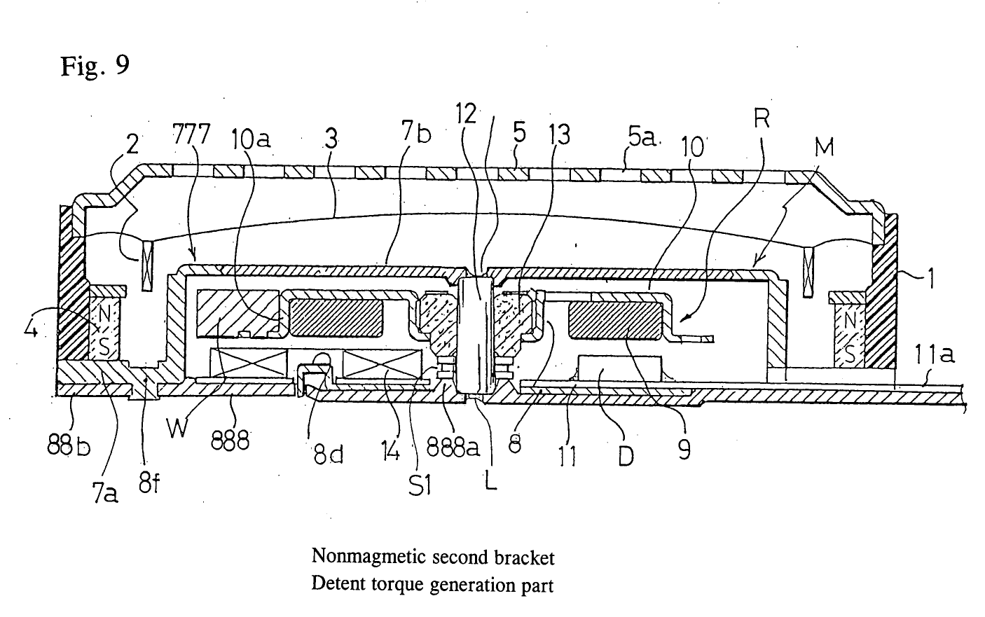

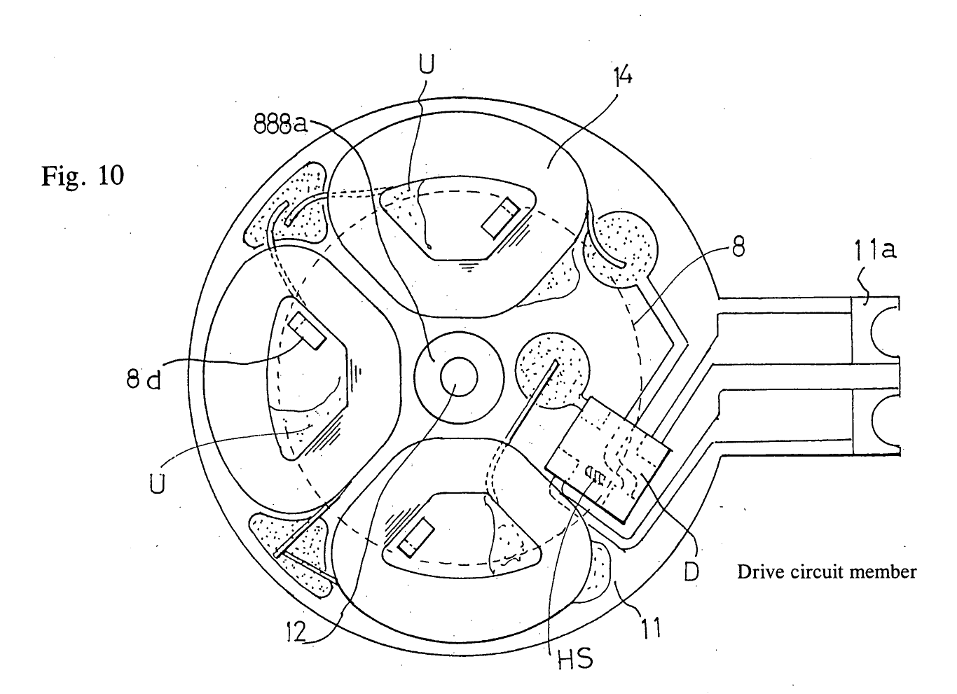

FIGS. 9 and 10 illustrate another embodiment relating to FIG. 8. Elements identical to those of the above embodiments are given the same reference symbols and explanation thereof is omitted.

The yoke bracket 8 is attached to a nonmagnetic second bracket 888, and the shaft 12 is fitted in the shaft bearing portion 888a and laser welded at point L from the outside. This second bracket is formed of nonmagnetic stainless with thickness of 0.15 mm-0.3 mm. A housing is constituted by the second bracket 888 and case 777, and the outer periphery 88b of the second bracket 888 overlaps with the flange 7a extending outward in the radial direction from the lateral periphery magnetic portion of the case 777, and is attached by a recess and protrusion crimping portion 8f.

The detent torque generation part 8d is configured so that a tip thereof is positioned and fitted into the second bracket 888, and outwardly in the radial direction is magnetically separated from the housing by mechanical separation.

A stator is constituted as follows. A stator base 11 comprising a print wiring board is attached to the yoke bracket 8. On the stator base 11, when the number of magnetic pole pieces of the magnet 4 of the rotor R to be assembled is (2n) (n being an integer 2 or larger, here, the magnet is magnetized into four magnetic pole pieces alternatingly NS), there are provided, integrally with the stator base 11 and in the radial direction, a plurality (here, three) of single-phase wiring type air-core armature coils 14, an Integrated-chip drive circuit member D with a sensor incorporated therein disposed in the stator base 11 so as not to overlap with the air-core armature coils 14 when seen from the plan view, and a feed terminal part 11a for input in the drive circuit member D.

The rotor R comprises the axial air-gap magnet 9 having a plurality (here, four) of magnetic pole pieces and the rotor yoke 10 holding the magnet 9, and is rotatably fitted, via the bearing 13 attached to the receiving portion in the center of the rotor yoke 10, on the shaft 12 disposed on the shaft bearing portion 888a of the second bracket 888 of the stator and laser welded at the point L from the outside.

Further, the rotor R is constituted such that the eccentric weight W is attached to the flange extending in the radial direction on the outer periphery of the rotor yoke 10 by engaging recesses and protrusions, making the rotor R an eccentric rotor that causes centrifugal vibrations to be generated and allows the motor to function as a vibration motor. The eccentric rotor R thus configured is rotatably fitted on the shaft 12 via three thrust washers S1 stacked so as to reduce brake loss.

The thrust washers S1 have different outer diameters. This is to avoid cases where, as in a case of washers with the same diameter, burrs interlock with each other, causing a clutch action and causing washers in a position of non-rotation to rotate.

The yoke bracket 8 is made of magnetic stainless steel with thickness of 0.15 mm-0.3 mm (preferably 0.2 mm), and on a position within the air-core armature coils separated in the radial direction from the shaft bearing portion 888a in the center of the yoke bracket 8 by an opening angle of at least 15° (here, roughly 17°) from the center of each coil, a detent torque generation part 8d protrudes upwardly through the stator base 11 to an extent not exceeding the upper surface of the coils 14. Three air-core armature coils 14 are eccentrically disposed with an opening angle of 90° and the magnet 9 of a rotor to be assembled comprises four magnetic pole pieces. The positional relationship of the detent torque generation part 8d and single-phase air-core armature coils 14 is set so that the opening angle of the effective conduction portion of the air-core armature coils is as wide as possible, corresponding to the magnetic pole pieces of the magnet (described below), and the shape of the detent torque generation part 8d, as well as the size thereof, is preferably set so as to attain the minimum detent torque when stopped by magnetism of the magnet.

Here, the reason for shifting the detent torque generation part 8d in the coil at about 17° is so that, whether a magnetic pole piece peak has stopped or whether a neutral portion has stopped, no start error occurs because of the position of a sensor incorporated in a drive circuit member coming to a neutral zone of the magnet. This angle may be widened up to about 22.5° so as to attain a greater effective conductive portion; however, because the problem may arise of coils having insufficient windings, suitable positions are selected with consideration given to impact on power.

With such a constitution, despite reduction in size of three single-phase wiring type air-core armature coils, sufficient start torque can be attained.

As described above, the present invention has a fixed shaft type constitution, but it may also be used in a rotary shaft type constitution.

Various other modifications may be made in the invention without departing from the technological essence and spirit thereof. Therefore, the above described embodiments merely serve to illustrate the invention and should not be construed as limiting. The technological scope of the invention is defined in the claims and is not restricted by the detailed description of the invention.

Drawings:

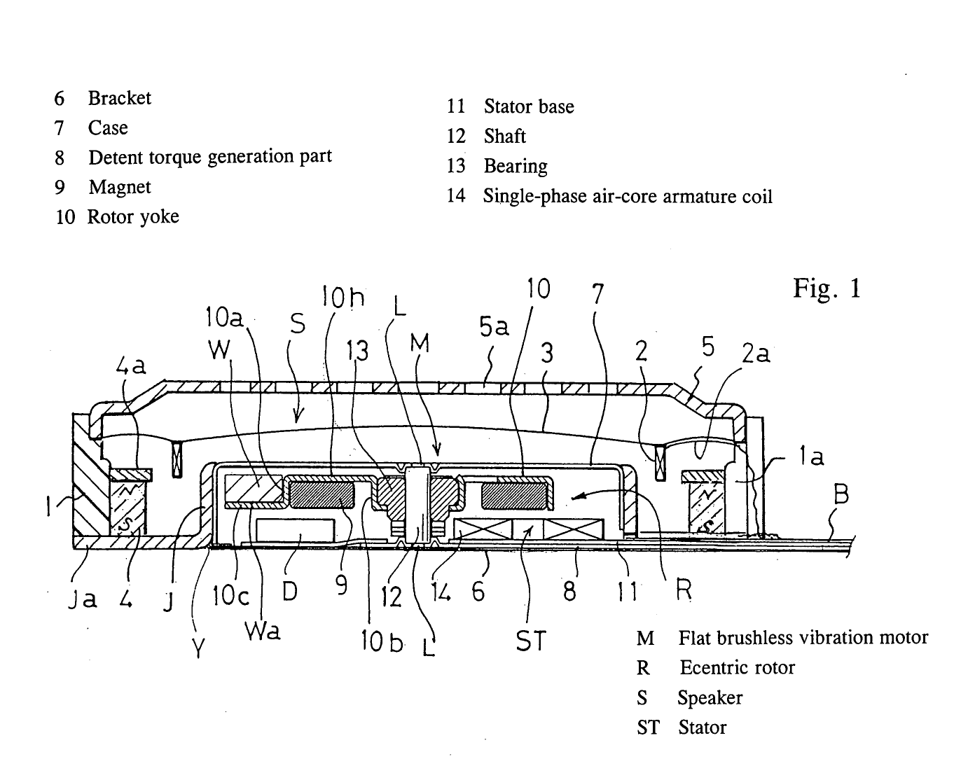

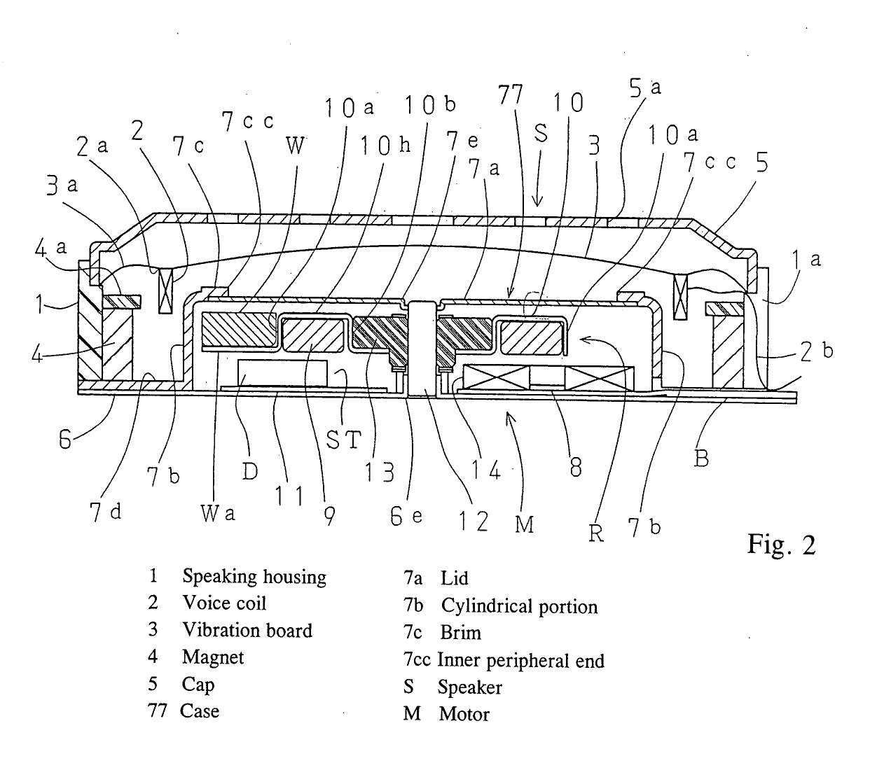

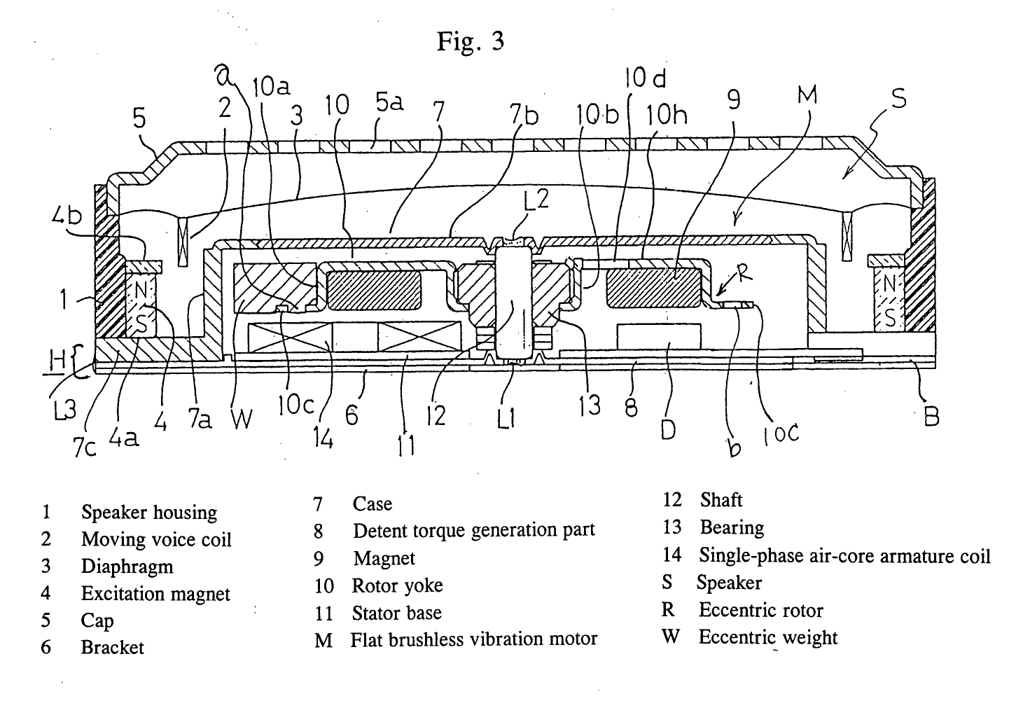

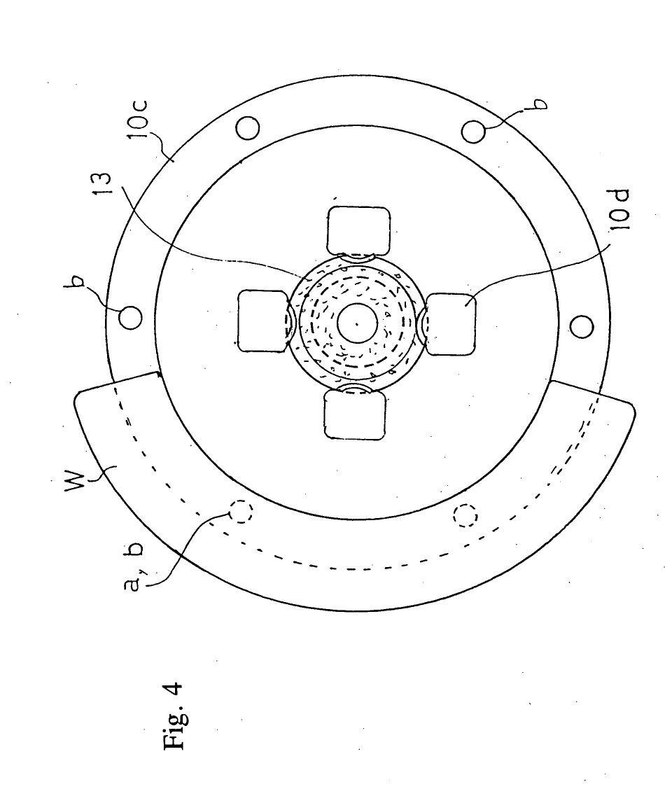

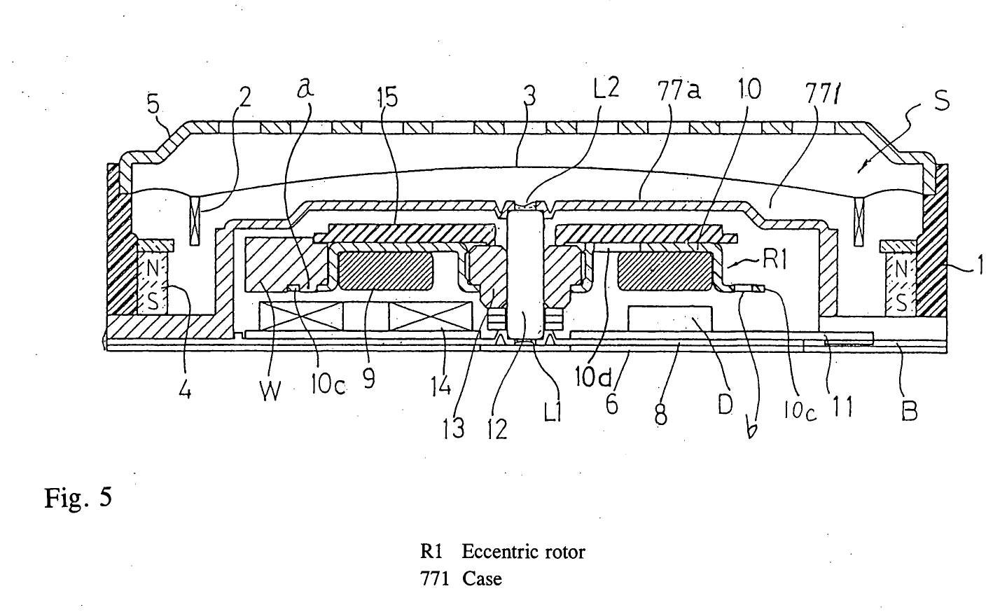

FIG. 1

6: Bracket
7: Case
8: Detent torque generation part
9: Magnet
10: Rotor yoke
11: Stator base
12: Shaft
13: Bearing
14: Single-phase air-core armature coil
M: Flat brushless vibration motor
R: Eccentric rotor
S: Speaker
ST: Stator
   FIG. 2
1: Speaker housing
2: Voice coil
3: Vibration board
4: Magnet
5: Cap
77: Case
7a: Lid
7b: Cylindrical portion
7c: Brim
7cc: Inner peripheral end
S: Speaker
M: Motor
   FIG. 3
1: Speaker housing
2: Moving voice coil
3: Diaphragm
4: Excitation magnet
5: Cap
6: Bracket
7: Case
8: Detent torque generation part
9: Magnet
10: Rotor yoke
11: Stator base
M: Flat brushless vibration motor
12: Shaft
13: Bearing
14: Single-phase air-core armature coil
S: Speaker
R: Eccentric rotor
W: Eccentric weight
   FIG. 5
R1: Eccentric rotor
771: Case
   FIG. 8
Nonmagnetic second bracket
Detent torque generation part
   FIG. 9
Nonmagnetic second bracket
Detent torque generation part
   FIG. 10
Drive circuit member

What we claim is:

1. A flat brushless vibration motor comprising:
a housing at least one part of which is made nonmagnetic or weakly magnetic;
an eccentric rotor rotatably accommodated in the housing via a shaft;
the eccentric rotor comprising a rotor case, an axial air-gap magnet held in this rotor case, a nonmagnetic eccentric weight fixed on the rotor case outward of this magnet, and a shaft bearing portion disposed on the rotor case inward of the magnet;
a stator disposed on a portion of the housing and driving the eccentric rotor across an axial gap; and
the stator comprising a shaft support portion provided in the center, a bracket having a detent torque generation part formed of a magnetic body and disposed on the periphery of the shaft support portion, a stator base attached to the bracket, at least two air-core armature coils wired in a single-phase and provided in this stator base, a drive circuit member disposed so as not to overlap with the air-core armature coils and supplying electric to the air-core armature coils, and a feed terminal to be connected to the drive circuit member.

2. A flat brushless vibration motor according to claim 1, wherein the housing is constructed so as to extend radially outward at the bottom as a flange for attachment.

3. A flat brushless vibration motor according to claim 1, wherein to avoid influence from magnetic field leakage of the axial air-gap magnet on the housing, the housing is formed of a nonmagnetic or weakly magnetic body, excluding at least the detent torque generation parts.

4. A flat brushless vibration motor according to claim 1, wherein a case constituting the housing comprises a magnetic body on the lateral periphery, and a part of a ceiling portion is formed of a nonmagnetic or weakly magnetic body and assembled with the magnetic body on the lateral periphery.

5. A flat brushless vibration motor according to claim 3, wherein the eccentric rotor comprises magnetic balance means comprising a magnetic body having an outer diameter concentric to the rotation center outward of the axial air-gap magnet.

6. A flat brushless vibration motor according to claim 5, wherein magnetic balance means serves as a brim portion extending along the entire periphery of the rotor case in the radial direction, and on one part of this brim portion, an arc-shaped nonmagnetic eccentric weight is disposed by combining recesses and protrusions.

7. A flat brushless vibration motor according to claim 1, wherein the case ceiling portion is slightly larger than the outer diameter of the axial air-gap magnet and swells upward in the axial direction.

8. A flat brushless vibration motor according to claim 7, wherein an eccentric rotor auxiliary plate is accommodated in the swelled portion, so that the eccentric weight is held down by a portion of the outer periphery thereof, and a bearing is held down by a portion of the inner periphery thereof.

9. A flat brushless vibration motor according to claim 1, comprising a yoke bracket formed of a magnetic body as a part of the housing, a shaft support portion disposed in the center of the yoke bracket, at least two detent torque generation parts disposed radially outward of the shaft support portion, at least two single-phase wiring type air-core armature coils that are fixed to the stator base when the number of magnetic pole pieces for the magnet of the rotor to be assembled is (2n) (n being an integer 2 or larger), a drive circuit member disposed on the stator base so as not to overlap with the air-core armature coils when seen from the plan view, and a feed terminal part for input in the drive circuit member and radially provided integral with the stator base, wherein the detent torque generation part axially extends so that, on an inner diameter portion of the air-core armature coils integral with a yoke bracket, it is positioned at least 12° from the center of the coils.

10. A flat brushless vibration motor according to claim 9, wherein a detent torque generation part disposed on the bracket side is magnetically separated from a magnetic body on the lateral periphery of the housing.

11. A flat brushless vibration motor according to claim 10, wherein a plurality of the detent torque generation parts are radially provided from the center at a magnetism opening angle roughly the same as, or an integral multiple, that of the magnetic pole of an axial air-gap magnet to be assembled, the tips thereof, as means for magnetic separation, are cut off from the magnetic member constituting the housing, and the detent torque generation parts are disposed on a nonmagnetic end bracket constituting a bracket which is a part of the housing.

12. A flat brushless vibration motor according to claim 11, wherein the nonmagnetic end bracket is made of a metal body, is thicker than a detent torque generation part, and comprises a shaft support portion in the center, the center of the detent torque generation part is press fitted on the shaft support portion, and the cut-off tip is embedded in the nonmagnetic end bracket.

13. A flat brushless vibration motor according to claim 10, comprising a shaft bearing portion in the center of one of the above brackets, at least two detent torque generation parts disposed in radially outward thereof, and when a stator base comprising a print wiring board is attached to the bracket and the number of magnetic pole pieces for the magnet of the rotor to be assembled is (2n) (n being an integer 2 or larger), at least two single-phase wiring type air-core armature coils fixed on the stator base; a drive circuit member disposed on the stator base so as not to overlap with the air-core armature coils when seen from the plan view, a feed terminal part for input in the drive circuit member and provided integral with the stator base in the radial direction; the rotor comprising an axial air-gap magnet having a plurality of magnetic pole pieces and a rotor yoke holding the magnet, wherein the rotor is rotatably fitted on the stator via the shaft, and accommodated in a housing formed of a case in which a magnetic body is provided on a lateral periphery and the brackets, and the detent torque generation part axially extends so that, on an inner diameter portion of the air-core armature coils integrally with a yoke bracket, it is positioned at least 12° from the center of the coils.
